(19) United States
(12) Patent Application Publication
(10) Pub. No.: US 2017/0143580 A1
(43) Pub. Date: May 25, 2017

(54) MASSAGE METHOD AND APPARATUS

(71) Applicant: LARRY MERCER, FORT WORTH, TX (US)

(72) Inventor: LARRY MERCER, FORT WORTH, TX (US)

(21) Appl. No.: 15/361,353

(22) Filed: Nov. 25, 2016

Related U.S. Application Data
(60) Provisional application No. 62/260,119, filed on Nov. 25, 2015.

(51) Int. Cl. A61H 15/00; A61H 7/00

(52) U.S. Cl. CPC A61H 15/00; A61H 7/002; A61H 2201/0157; A61H 2205/12; A61H 2015/0014; A61H 2209/00

(57) ABSTRACT

A system and method for treatment of diabetic peripheral neuropathy is illustrated and described. The system is a portable massage system for application with the feet. The system includes a frame to resist flexure and configured to hold a rod assembly. The rod assembly is elevated by the frame and configured to rotate upon the application of a tangential force to a surface of the rod assembly. The rod assembly includes a rod having two ends. Each end of the rod is inserted into a portion of the frame. Additionally, the assembly includes a grip configured to surround a portion of the rod and used to increase friction upon contact. Rotation of the rod assembly selectively applies pressure to stimulate blood flow.

### CLAIM OF PRIORITY

This application claims the benefit of U.S. Provisional Application No. 62/260,119 filed 25 Nov. 2015. The information contained therein is hereby incorporated by reference.

### BACKGROUND

1. Field of the Invention

The present application relates generally to a manually operated device for providing a massage, in particular, the device is used to massage the lower portion of a foot.

2. Description of Related Art

Individuals with diabetes can often be susceptible to foot problems, such as reduced blood flow and diabetic peripheral neuropathy (nerve damage). A lack or decreased reduction in circulation in the feet results in less oxygen and nutrients reaching the feet. This can lead to slower healing from blisters, cuts, and sores. Diabetic peripheral neuropathy can cause either numbness or sharp sensitive pain in the feet. When numb, a diabetic individual may not recognize the presence of sores, blisters, or cuts on the feet which further complicates the healing process. When sharp pains are experienced the act of walking or any mobility becomes difficult. Medications and tender loving care may be prescribed to alleviate the pain and better cope with the effects of diabetes and the feet. However, neither of those can provide sufficient enough treatment as needed by the individual. It is known that electronic massaging devices may be prescribed and used to attempt to alleviate these harmful effects. These may be useful but are can be restrictive in their use in that they need a ready port for providing power. Outlets are not always accessible. Additionally, motorized devices tend to be heavier and more difficult to carry. Although great strides have been made in this area, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a portable massage system according to an embodiment of the present application;

FIG. 2 is a perspective view of a bushing used within the massage system of FIG. 1;

FIG. 3 is a perspective view of exemplary rods used in the massage system of FIG. 1;

FIG. 4 is a perspective view of grips used in the massage system of FIG. 1;

FIG. 5 is a perspective view of the grips of FIG. 4 coupled to a rod of FIG. 3; and

FIG. 6 is a perspective view of an alternative embodiment of a rod assembly used in the massage system of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method of use in accordance with the present application overcomes one or more of the above-discussed problems commonly associated with diabetic peripheral neuropathy. Specifically, the system of the present application is configured provide a portable and self-performing massaging apparatus that may be discretely used by an individual to care for their feet. The rods may optionally be configured to be removable from the frame to allow the user to roll their feet along the ground. These and other unique features of the system are discussed below and illustrated in the accompanying drawings.

The system and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The device and method of the present application is illustrated in the associated drawings. A portable massaging system is configured to allow a user to discretely massage their feet while sitting for work at a desk or lounging at home. The system may also be used while standing, however, the predominant use is expected to be done while sitting in some manner. The portable massaging system may be used as a full assembly or broken down for use individually with the rods. In each configuration, the portable massage system permits ease of use for the user. The direct massaging of a user's foot works to alleviate pain and difficulties that arise with diabetic peripheral neuropathy in the feet by allowing a user to roll their foot across rotating textured pads. Additional features and functions of the device are illustrated and discussed below.

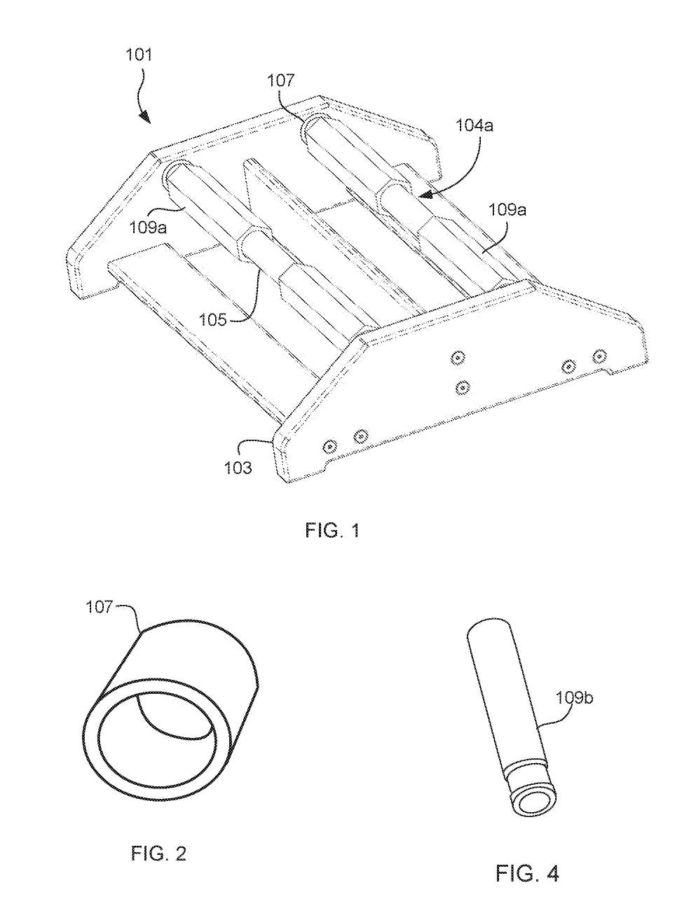

Referring now to the drawings wherein like reference characters identify corresponding or similar elements throughout the several views. Referring now to FIGS. 1-5 wherein like reference characters identify corresponding or similar elements in form and function throughout the several views. The following Figures describe a portable massage system 101 as described briefly above. Referring in particular to FIG. 1 in the drawings, the portable massage system 101 is illustrated.

System 101 includes a body or frame 103 used to support one or more rod assemblies 104a. Assemblies 104a are supported within frame 103 at opposing ends. A bushing 107 is included within system 101 to allow for the free rotation of assembly 104 within frame 103. Rod assemblies 104a are suspended by frame 103 above the surface of the ground.

Frame 103 is structurally rigid in form and in material. As seen in FIG. 1, frame 103 forms a rigid rectangular shape. Various different elongated members are integrally coupled together in the predefined shape forming a modular structure. Other embodiments may choose to form the frame 103 as a single member, for example with injection molding. Although not shown here, it is understood that other embodiments may use a modular frame wherein selected portions of the frame may be removed, interchanged, or selectively aligned relative at various angles. The modular feature of frame 103 would permit easier storage and portability. The selective alignment feature would allow for frame 103 to change between various shapes (i.e. non-rectangular) to adjust to size and space restrictions near a user's feet.

As seen in particular with FIG. 2, bushing 107 is illustrated. Assemblies 104a are configured to rotate as a foot applies a tangential force across a surface of grip 109a. Bushing 107 is configured to allow for the relative free movement of the rod in relation to frame 103. Bushing 107 is located within a pocket of frame 103. Bushing 107 may be press fit into the pocket or may be adhered with an adhesive. In some embodiments, bushing 107 may include the use of lubrication. For example, bushing 107 may be a self-lubricating bushing. In instances where assembly 104a is removed and interchanged with one of a different sized outer diameter, bushing 107 may be interchanged as well.

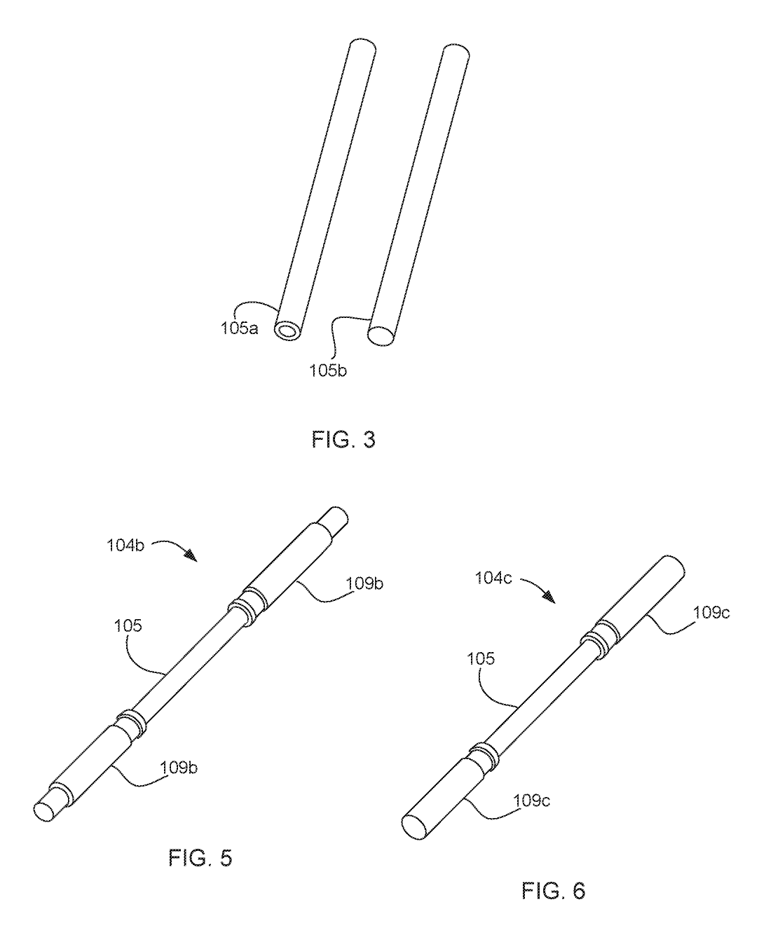

Referring in particular to FIG. 3 in the drawings, perspective views of rods 105 are illustrated. Assembly 104a includes a combination of rods 105 and grips 109a. Rods 105 are elongated cylindrical rods configured to be rotated along a central axis by the motion of a user's foot. It is understood that many types of materials may be used to form rod 105. One such material is aluminum. Others are contemplated. It is preferred that a material is selected to keep the weight of rods 105 down to a minimum level to ease a user's ability to rotate the rod. As seen in particular with FIG. 3, rods 105 are illustrated with different exemplary embodiments. Rod 105a has a hollowed core to decrease weight. Rod 105b includes a solid core center. The diameters of both rods 105a/105b may be changed or modified to reflect different load capacities.

Grips 109a are inserted around the exterior surface of rods 105. These may be sealingly coupled for permanent attachment or may be configured to be removable. In the preferred embodiment, grips 109a are removable. As seen in FIG. 1, grips 109a include a particular contour. As shown, this contour is an overall hexagonal shape with a series of radial edges along its length. It is understood that other types of contours may be realized. The selection of a type of contour may affect the effectiveness of the treatment to a user.

Grips 109a are located along the outer surface of rod 105 and configured to increase friction when contacted by the user's foot. Grip 109a has opposing open ends for passage of rod 105. Ideally a plurality of grips 109a are used, one for each foot to permit simultaneous treatment. Grips 109a are designed with a selectively textured and contoured outer surface. It is understood that selected contours and textures may appeal to different people and may be more suited for different types of foot conditions suffering from diabetic peripheral neuropathy. Therefore, grips 109a are configured to be interchangeable from rod 105.

Referring now also to FIG. 4 in the drawings, an alternative embodiment of grip 109a is illustrated. Grip 109b is similar in form and function to grip 109a. A distinguishing difference with grip 109b is that the outer surface contour of grip 109b is relatively smooth and rounded. As seen in FIG. 5, assembly 104b is shown wherein grips 109a are swapped out with grips 109b. The function of assembly 104b is similar to that of assembly 104a. The ends of rod 105 are configured to extend past and through grips 109a/109b for insertion into bushing 107.

In use, a user is able to locate frame 103 under their feet and roll their feet along assembly 104a. As seen in FIG. 1, two rod assemblies 104a are shown. A user may elect to roll their feet along both rod assemblies 104a simultaneously to allow the user to increase the range of motion of their feet along system 101. The user then rolls their feet in an alternating forward and backward motion. As the feet contact rod assemblies 104a, pressure is applied to the bottom of the feet. This motion helps to facilitate increased blood flow. An advantage of this system is that the user is able to discretely use the system out of the knowledge of others. No motorized machine is operating. No noise is generated. No power source is required either.

Referring now to FIG. 6 in the drawings, an alternative embodiment of assembly 104a and 104b is illustrated. Assembly 104c includes rod 105 and either of grips 109a and 109b. Alternatively, grips 109c may be used. Grips 109c are similar in form and function to that of grips 109a/109b except that grips 109c are configured with a sealed end to prevent the full passage of rod 105 through both ends of the grip.

An alternative method of using system 101 and rod assembly 104a-c involves the use of assembly 104a-c outside of frame 103. In the preferred embodiment, system 101 elevated rod assembly 104 with frame 103. However, situations are contemplated wherein a user may wish to have rod 105 roll along the floor. This results in a less elevated position for the feet. Additionally, use of only rod 105 and grips 109 allows for a greater ease for storage and transportation. Rod 105 may therefore be removed from frame 103 and be used along the floor. It is understood that grips 109a-b may be retained or may be swapped out for grips 109c that contain a closed end.

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A portable massage system, comprising:
a frame to resist flexure;
a rod assembly elevated within the frame and configured to rotate upon the application of a tangential force to a surface of the rod assembly, the rod assembly including:
a rod having two ends, each end being inserted into a portion of the frame; and
a grip configured to surround a portion of the rod and used to increase friction upon contact;
wherein rotation of the rod assembly selectively applies pressure to stimulate blood flow.

2. The system of claim 1, wherein the frame is modular

3. The system of claim 1, wherein the frame is injection molded

4. The system of claim 1, further comprising:
a bushing in the frame configured to reduce friction caused by the rotation of the rod.

5. The system of claim 1, wherein the rod has a hollow core.

6. The system of claim 1, wherein the rod has a solid core.

7. The system of claim 1, wherein the grip includes two open ends to permit the rod to pass entirely through its length.

8. The system of claim 1, wherein the grip includes a sealed end.

9. The system of claim 1, wherein the grip includes a rounded contour.

10. The system of claim 1, wherein the grip includes an edged contour.

11. A method of massaging feet so as to increase blood flow, comprising:
providing the portable massage system of claim 1;
selecting the rod assembly;
placing the rod assembly in the frame;
applying tangential pressure across a surface of the rod assembly; and
alternating movement across the rod assembly to create a massaging effect.

12. The method of claim 11, further comprising:
interchanging the rod in the rod assembly

13. The method of claim 11, further comprising:
interchanging the grip in the rod assembly.

14. The method of claim 11, further comprising:
removing the rod assembly from the frame for use.

15. The method of claim 11, wherein the grip permits the rod to pass entirely through its length.

16. The method of claim 11, wherein the grip includes a sealed end.

17. The method of claim 11, wherein the grip includes a rounded contour.

18. The method of claim 11, wherein the grip includes an edged contour.
